(19) United States
(12) Patent Application Publication
(10) Pub. No.: US 2006/0023604 A1
(43) Pub. Date: Feb. 2, 2006

(54) Signal processing apparatus and method for recording medium

(75) Inventors: Hideyuki Yamakawa, Kawasaki-shi (JP); Koichi Otake, Yokohama-shi (JP); Yukiyasu Tatsuzawa, Yokohama-shi (JP); Hiroyuki Moro, Fussa-shi (JP); Toshihiko Kaneshige, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/190,072

(22) Filed: Jul. 27, 2005

(30) Foreign Application Priority Data
Jul. 30, 2004 (JP) 2004-223725

(51) Int. Cl. G11B 20/10; G11B 5/09

(52) U.S. Cl. 369/59.22; 369/59.1

(57) ABSTRACT

There is provided an apparatus which can flexibly cope with both of a signal reproduction process for a region with high recording density and a signal reproduction process for a region with low recording density. The apparatus includes a waveform equalizing circuit which subjects data read out from an optical disk to a waveform equalizing process, a plurality of PRML processors of different classes supplied with an output signal of the waveform equalizing circuit, a switch which selects one of output signals of the plurality of PRML processors and supplies the selected output signal to a decoder, and a controller which controls the switch according to high-density and low-density regions with different recording densities of the optical disk to set a selection state in which a corresponding one of the output signals of the plurality of PRML processors is selected.

### CROSS-REFERENCE TO RELATED APPLICATIONS

This application is based upon and claims the benefit of priority from prior Japanese Patent Application No. 2004-223725, filed Jul. 30, 2004, the entire contents of which are incorporated herein by reference.

### BACKGROUND OF THE INVENTION

1. Field of the Invention

This invention relates to a signal processing apparatus and method for a recording medium which is suitable for a process of adequately processing a signal read out from an optical disk or hard disk with high recording density, for example.

2. Description of the Related Art

Recently, as an optical disk, an optical disk which is subjected to a recording/reproducing operation by use of a bluish-purple laser has been developed in addition to an optical disk which is subjected to a recording/reproducing operation by use of a red laser. In the case of an optical disk on or from which data is recorded or reproduced by use of a bluish-purple laser diode, the recording density can be enhanced since the wavelength of bluish-purple laser light is shorter than that of red laser light.

In a recording/reproducing apparatus which records or reproduces information with respect to the optical disk by use of the bluish purple laser, a readout signal is subjected to the reproducing process using a Partial Response and Maximum Likelihood (PRML) identification system and the readout precision is enhanced. As an explanatory material about PRML, Jpn. Pat. Appln. KOKAI Publication No. 2003-16733 is provided.

In recent years, when a reproducing apparatus is considered, various types of optical disks are provided and some of the optical disks have a region with high recording density and a region with low recording density. In the reproducing apparatus, it is desired to reproduce both of the optical disk with high recording density and the optical disk with low recording density. However, in the signal reproducing process using the PRML system that designed for high recording density, there occurs a problem that it cannot be attained at the time of reproduction of a region with low recording density.

### BRIEF SUMMARY OF THE INVENTION

An object of the embodiments is to provide a signal processing apparatus and method which can flexibly cope with both of signal reproducing processes for regions with low and high recording densities.

According to one aspect of this invention, there is provided a reproducing circuit which reads out a signal from an optical disk with high recording density by use of a bluish-purple laser and comprises a PRML processing function for a region with high recording density, a PRML processing function for a region with low recording density, and means for selectively switching the processing functions. Specifically, the reproducing circuit includes a waveform equalizing circuit which waveform-equalizes data read out from an optical disk, a plurality of PRML processors of different classes supplied with an output signal of the waveform equalizing circuit, a switch which selects one of output signals of the plurality of PRML processors and supplies the selected output signal to a decoder, and a controller which controls the switch according to high-density and low-density regions with different recording densities of the optical disk to set a selection state in which a corresponding one of the output signals of the plurality of PRML processors is selected.

By use of the above means, it becomes possible to adequately reproduce a signal in each of the regions with high and low recording densities.

Additional objects and advantages of the embodiments will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing the configuration of a signal processing apparatus according to one embodiment of this invention;

FIG. 2 is an explanatory view showing an example of an optical disk according to one embodiment of this invention;

FIG. 3 is an explanatory diagram for illustrating the recording density of each area of the optical disk shown in FIG. 2;

FIG. 4 is a diagram showing the relation between the reproducing signal spectrum and the partial response characteristic according to one embodiment of this invention; and

FIG. 5 is a configuration explanatory diagram showing another embodiment of this invention.

### DETAILED DESCRIPTION OF THE INVENTION

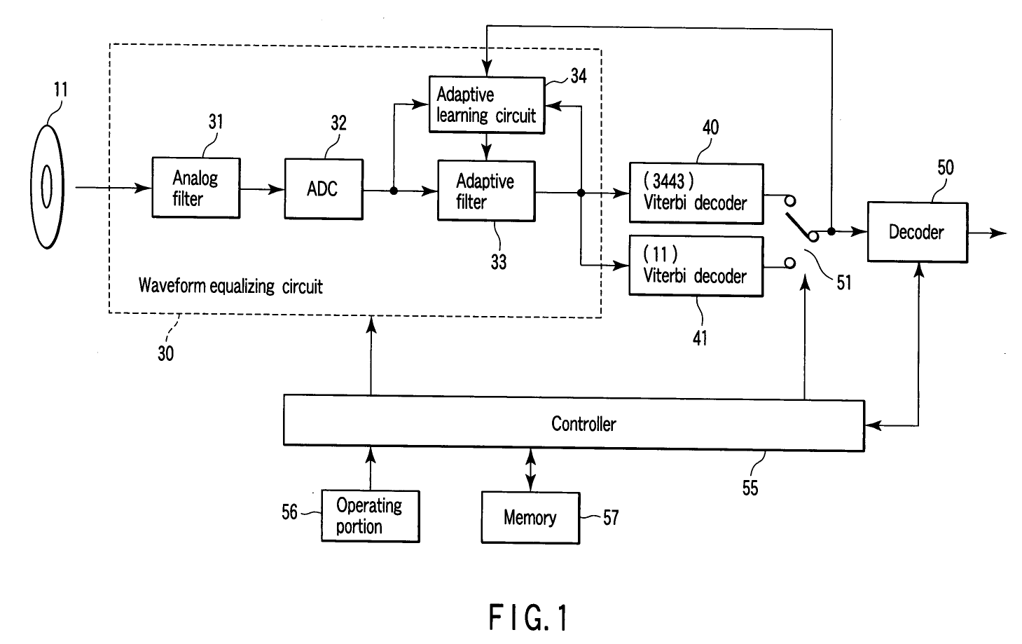

There will now be described embodiments of this invention with reference to the accompanying drawings. In FIG. 1, the configuration of an optical disk reproducing apparatus which utilizes a signal processing apparatus according to one embodiment of this invention is shown. In FIG. 1, a reference symbol 11 denotes an optical disk (recording medium), a reference symbol 30 denotes a waveform equalizer configured by analog and digital circuits, reference symbols 40, 41 denote Viterbi decoders (maximum likelihood decoders), a reference symbol 50 denotes a decoder (demodulator), and a reference symbol 51 denotes a selection switch. The waveform equalizer 30 includes an analog filter 31, analog-to-digital converter (ADC) 32, adaptive filter 33 and adaptive learning circuit 34. The Viterbi decoder 40 is a maximum likelihood decoder corresponding to a partial response of Class 3443. The Viterbi decoder 41 is a maximum likelihood decoder corresponding to a partial response of Class 11. One of the two Viterbi decoders 40, 41 is selected by the selection switch 51.

The adaptive learning circuit 34 performs a control operation to set an optimum characteristic of the adaptive filter 33 based on input and output signals of the adaptive filter 33 and an output signal of the Viterbi decoder. Output signals of the adaptive filter 33 and selection switch 51 are fed back to the adaptive learning circuit 34.

In FIG. 1, the high-frequency noise of a reproduction signal read out from the optical disk 11 by use of bluish-purple laser light is eliminated by the analog filter 31. An analog signal of the thus noise-eliminated waveform is converted into a digital signal by use of the analog-to-digital converter (ADC) 32. The converted digital signal is input to the adaptive learning circuit 34 and adaptive filter 33. The characteristic of the adaptive filter 33 is controlled based on an output signal of the adaptive learning circuit 34 and an input signal is subjected to a waveform equalizing process. The bluish-purple laser light is emitted from a laser diode contained in a known optical head via an objective lens.

Binary data is detected by the Viterbi decoders 40 and 41. One of the binary data items is selected by the selection switch 51 and input to the decoder 50. The binary data is subjected to a demodulation process in the decoder 50 and output as user data.

Recently, a portion with high linear recording density in which normal data is recorded and a portion with low linear recording density called a system lead-in area are provided on the same medium used as an optical disk.

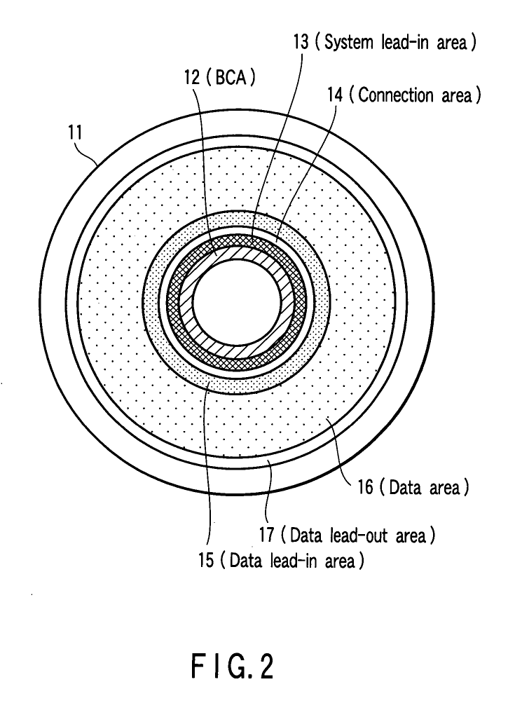

In FIG. 2, the optical disk 11 is shown. A burst cutting area (BCA) 12 is provided outside a clamp hole formed in the central portion of the optical disk. Further, a system lead-in area 13 is provided outside the area 12, a connection area 14 is provided outside the area 13 and a data lead-in area 15 is provided outside the area 14. In addition, a data area 16 is provided outside the lead-in area 15 and a lead-out area 17 is set outside the area 16.

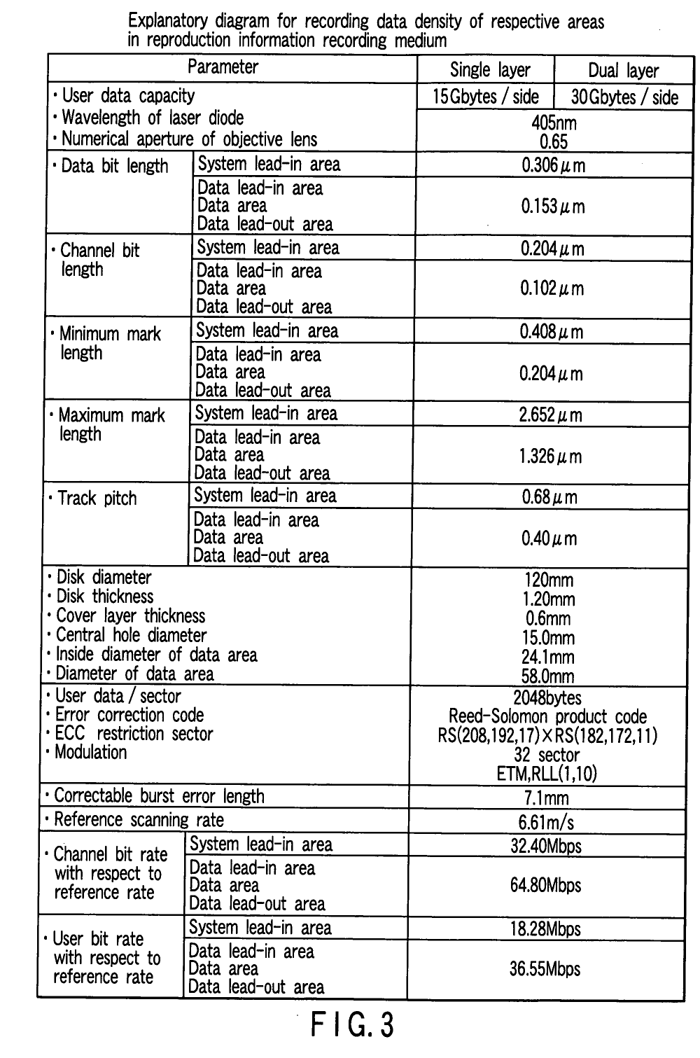

In FIG. 3, the data bit length, channel bit area, minimum mark length, track pit and the like of each area are defined. As is understood from the table, in the optical disk 11, the data bit lengths and channel bit lengths of the system lead-in area 13 and data lead-in area 15 are greatly different. Therefore, when data in the portion with low linear recording density called the system lead-in area is reproduced, there occurs a problem that data cannot be successfully reproduced with a partial response of Class 1221, Class 3443, Class 12221 or the like because the recording density is excessively low.

Therefore, in this invention, the reproducing operation is performed by use of a partial response of Class 11, for example, in the area (system lead-in area) with low recording density.

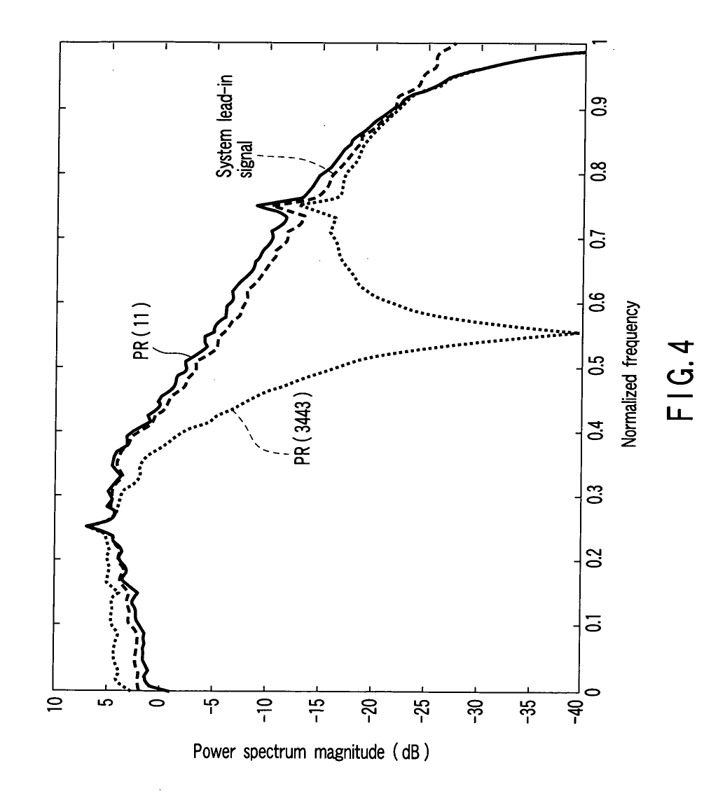

FIG. 4 is a diagram showing a reproduction signal spectrum in the system lead-in area and a characteristic of a partial response of representative classes. As is clearly seen from FIG. 4, it is understood that Class 11 is suitable in the system lead-in area judging from the matching of the frequency characteristics.

Therefore, when data with normal density is reproduced, the Viterbi decoder 40 is selected by the selection switch 51 shown in FIG. 1 and the waveform equalizing process is performed to attain a class equivalent to Class 3443. When data in the area 13 with low recording density such as the system lead-in area is reproduced, the Viterbi decoder 41 is selected by the selection switch 51 and the waveform equalizing process is performed to attain a class equivalent to Class 11.

Thus, data recorded with different recording density can be reproduced by performing the waveform equalizing process to attain a partial response waveform of a different class according to the recording density of data to be reproduced and performing the Viterbi decoding process suitable for the selected class. In FIG. 1, a system controller 55 is connected to an operating section 56 and memory 57. The operating section 56 can receive an operation signal from a remote controller.

The controller 55 can evaluate the reproduction signal by use of a decoded signal from the decoder 50 or a decoded output signal. Whether the Viterbi decoder used at present is suitable or not can be determined based on the evaluated value. If it is not suitable, the switch 51 is controlled to use an output signal of the other Viterbi decoder. Further, it is also possible to control the switch 51, evaluate the decoded output signals of the Viterbi decoders 40 and 41 and select the decoder corresponding to a suitable output signal. When the quality of a decoded output signal is determined, the determination can be made based on an error rate in the decoder 50. For example, the decoded output signals of the Viterbi decoders 40 and 41 are subjected to an error correction process. Then, it is determined that the decoder corresponding to an output signal having a lower error rate is suitable.

Various methods can be used as the control method of the switch 51. For example, in the case of the optical disk 11, since the physical addresses thereof are determined, the controller 55 determines data read time of the system lead-in area 13 based on the physical address, controls the switch 51 and sets the selection state of the Viterbi decoder 41 when data in the system lead-in area 13 is reproduced.

The recording density may be different depending on the disk and it becomes necessary to switch the class of the decoder according to the recording density. In such a case, for example, when BCA information is read out, the type of the disk is determined and an adequate Viterbi decoder can be selected according to the thus determined type.

This invention is not limited to the above embodiment.

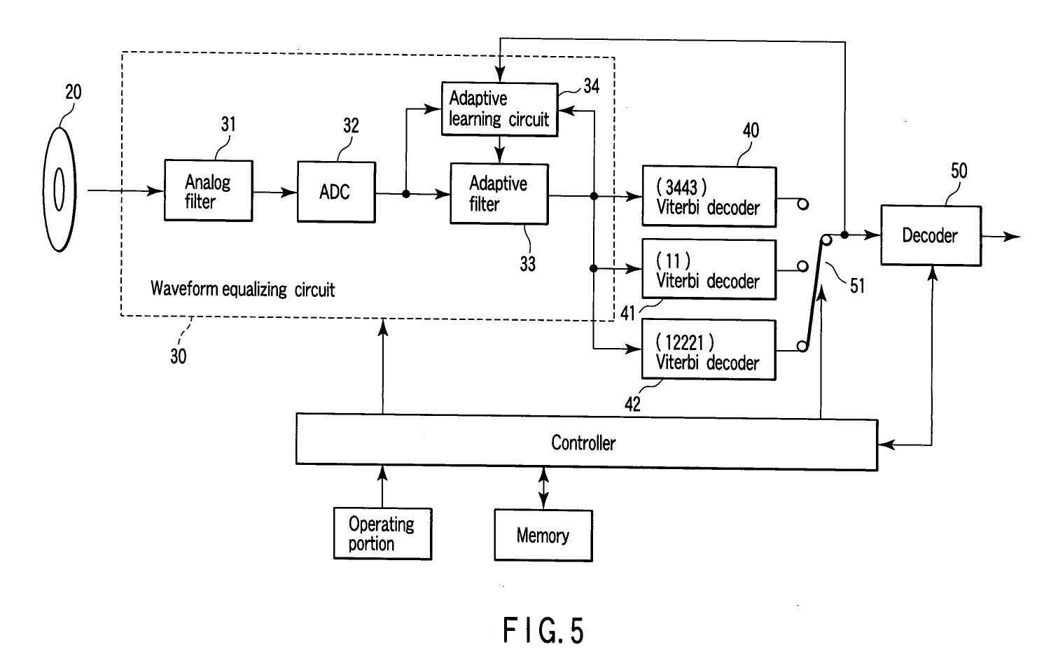

FIG. 5 is another configuration diagram showing the optical disk reproducing apparatus utilizing the signal processing apparatus according to one embodiment of this invention. For easy understanding, portions which are the same as those of FIG. 1 are denoted by the same reference numerals. The difference between FIGS. 1 and 5 lies in that a Viterbi decoder 42 is additionally provided in the configuration of FIG. 5. In according with this, a selection switch 51 is operated to select one of the three Viterbi decoders 40, 41 and 42.

In the case of the optical disk 11, data is recorded with different density depending on the type of a medium in a normal data area. That is, the reproduction signal spectrum has good matching with the partial response of Class 3443 in a reproduction-only medium and the reproduction signal spectrum has good matching with the partial response of Class 12221 in a rewritable medium. Therefore, when data in the data area of the reproduction-only medium is reproduced, the data reproduction process is performed by use of the partial response of Class 3443 and when data in the data area of the rewritable medium is reproduced, the data reproduction process is performed by use of the partial response of Class 12221. Further, when data in the system lead-in area of each of the reproduction-only medium and rewritable medium is reproduced, the data reproduction process is performed by use of the partial response of Class 11.

As described above, according to this invention, since the configuration of the signal processing apparatus which switches the classes of the partial response to match with the frequency characteristic of the reproduction signal according to the recording density of the recording medium is used, data items of media with a plurality of recording densities can be reproduced.

By the above means, signals in a region with high recording density and a region with low recording density can be adequately reproduced.

This invention is not limited to the above embodiments and can be embodied by modifying the constituents without departing from the technical scope at the embodying stage. Further, various inventions can be made by adequately combining a plurality of constituents disclosed in the above embodiments. For example, some constituents can be omitted from all of the constituents. Further, the constituents lying over the different embodiments can be adequately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A signal processing apparatus comprising:
a waveform equalizing circuit which subjects data read out from an optical disk to a waveform equalizing process,
a plurality of PRML processors of different classes supplied with an output signal of the waveform equalizing circuit,
a switch which selects one of output signals of the plurality of PRML processors and supplies the selected output signal to a decoder, and
a controller which controls the switch according to high-density and low-density regions with different recording densities of the optical disk to set a selection state in which a corresponding one of the output signals of the plurality of PRML processors is selected.

2. The signal processing apparatus according to claim 1, wherein the plurality of PRML processors include both of a PRML processing function of Class 3443 and PRML function of Class 11.

3. The signal processing apparatus according to claim 1, wherein the plurality of PRML processors include both of a PRML processing function of Class 12221 and PRML function of Class 11.

4. The signal processing apparatus according to claim 1, wherein the plurality of PRML processors include all of a PRML processing function of Class 12221, PRML processing function of Class 3443 and PRML function of Class 11.

5. The signal processing apparatus according to claim 1, wherein the optical disk has recording density which copes with a PRML process of Class 11 in a system lead-in area.

6. The signal processing apparatus according to claim 2, wherein the optical disk has recording density which copes with a PRML process of Class 11 in a system lead-in area.

7. The signal processing apparatus according to claim 3, wherein the optical disk has recording density which copes with a PRML process of Class 11 in a system lead-in area.

8. The signal processing apparatus according to claim 4, wherein the optical disk has recording density which copes with a PRML process of Class 11 in a system lead-in area.

9. The signal processing apparatus according to claim 1, wherein the controller determines a type of an area during a reproduction process of the optical disk, controls the switch according to the area and selectively switches the PRML processing function.

10. The signal processing apparatus according to claim 2, wherein the controller determines a type of an area during a reproduction process of the optical disk, controls the switch according to the area and selectively switches the PRML processing function.

11. The signal processing apparatus according to claim 3, wherein the controller determines a type of an area during a reproduction process of the optical disk, controls the switch according to the area and selectively switches the PRML processing function.

12. A signal processing method for a recording medium, comprising:
subjecting data read out from an optical disk to a waveform equalizing process in a waveform equalizing circuit,
supplying an output signal of the waveform equalizing circuit to a plurality of PRML processors of different classes,
selecting one of output signals of the plurality of PRML processors by use of a switch,
supplying the signal selected by the switch to a decoder, and
controlling the switch according to high-density and low-density regions with different recording densities of the optical disk by use of a controller and setting a selection state in which a corresponding one of the output signals of the plurality of PRML processors is selected.

13. The signal processing method according to claim 12, wherein the plurality of PRML processors include both of a PRML processing function of Class 3443 and PRML function of Class 11.

14. The signal processing method according to claim 12, wherein the plurality of PRML processors include both of a PRML processing function of Class 12221 and PRML function of Class 11.

15. The signal processing method according to claim 12, wherein the plurality of PRML processors include all of a PRML processing function of Class 12221, PRML processing function of Class 3443 and PRML function of Class 11.

16. The signal processing method according to claim 12, wherein the optical disk has recording density which copes with a PRML process of Class 11 in a system lead-in area.

17. The signal processing apparatus according to claim 12, wherein the controller determines a type of an area during a reproduction process of the optical disk, controls the switch according to the area and selectively switches the PRML processing function.
